(19) United States
(12) Patent Application Publication
(10) Pub. No.: US 2015/0225165 A1
(43) Pub. Date: Aug. 13, 2015

(54) System for Dispensing a Fluid Product Packaged in a Bottle

(71) Applicant: Albea Le Treport, Le Treport (FR)

(72) Inventors: Richard Bloc, Derchigny-Graincourt (FR); Herve Imenez, Feuquieres en Vimeu (FR)

(21) Appl. No.: 14/607,174

(22) Filed: Jan. 28, 2015

(30) Foreign Application Priority Data
Feb. 7, 2014 (FR) 14 00364

(51) Int. Cl. B65D 83/00; G01N 1/10

(52) U.S. Cl. CPC B65D 83/0022; G01N 1/10

(57) ABSTRACT

A system for dispensing a fluid product packaged in a bottle, the system comprising a device for sampling; a ring secured to the bottle having two upper arms arranged on either side of the nozzle which is provided with two external lugs, the arms each having an internal lug arranged in the axial continuation of an external lug to form a housing between them; a support having a dispensing duct, the arms being mounted in translation in the support; a push-button which is mounted in radial translation with respect to the support and which has two tabs each having an upper bearing surface bearing against an internal lug and a lower bearing surface bearing against an external lug, said bearing surfaces diverging radially so that a depression the push-button causes the lugs to separate in order to actuate the device by depressing the nozzle) and raising the bottle; an applicator being mounted in relative rotation on the support.

### CROSS-REFERENCE TO RELATED APPLICATION

The present application claims priority and benefit to French Patent Application FR-14 00364 filed Feb. 7, 2014. This application is incorporated by reference herein in its entirety.

### FIELD OF THE INVENTION

The invention relates to a system for dispensing a fluid product packaged in a bottle, as well as a method for assembling such a system.

### BACKGROUND OF THE INVENTION

In a particular application, the product is of the gel or cream type, for example for use in cosmetics or for pharmaceutical treatments. More particularly, the invention can allow for the application of a product such as a liquid lipstick (lip gloss) or a care product for lips.

Systems for dispensing comprising a device for sampling a product packaged in a bottle are known, for example formed of a pump, which have a body secured to said bottle in order to be supplied with product and a nozzle overmounting said body. In particular, the device for sampling can be actuated by reversible displacement of the nozzle over an axial course that is respectively descending for dispensing and ascending for suction of the product.

Conventionally, the displacement of the nozzle is actuated by a push-button which is mounted on the upper end of the nozzle, said push-button having a dispensing orifice in communication with said nozzle and an upper zone of axial bearing.

Document WO-2013/011246 proposes a system for dispensing comprising:
a ring secured to the bottle and wherein the body of the device for sampling is fixed in a sealed manner, said ring having two upper arms arranged on either side of the nozzle which is provided with two external lugs, said arms each having an internal lug arranged in the axial continuation of an external lug to form a housing between them;
a support having a duct for dispensing the product, the arms being mounted in translation in said support by placing the nozzle in communication with the dispensing duct;
a push-button for actuating the device for sampling which is mounted in radial translation with respect to the support, said push-button having two tabs arranged respectively in a housing formed between the lugs, said tabs each having an upper bearing surface bearing against an internal lug and a lower bearing surface bearing against an external lug, said bearing surfaces diverging radially so that a depression of the push-button causes the lugs to separate in order to actuate the device for sampling by depressing the nozzle and raising the bottle.

In particular, in this system for dispensing, the course and the effort of the actuating in translation of the push-button are reduced thanks to a combination of a depression of the nozzle with a raising of the bottle in order to carry out the actuating of the device for sampling. Moreover, this system can use a standard device for sampling, i.e. of the type that can be used for an axial actuating.

Furthermore, such a system can comprise an applicator which is mounted on the support, said applicator comprising an orifice which is in communication with the dispensing duct in order to dispense the product.

As such, in order to apply the product on a portion of the body, for example on the lips, a user can press on the push-button to dispense the product, then press and displace the applicator along said portion in order to spread said product on said portion, which constitutes a particularly intuitive gesture.

### SUMMARY OF THE INVENTION

However, in order to benefit from a gesture that is even more intuitive gesture and easily adaptable to the own habits of the user and/or to the position of the portion of the body whereon the user wants to apply the product, it can be advantageous to be able to selectively orient the applicator and more particularly its dispensing orifice, in particular in relation to the push-button.

To this effect, according to a first aspect, the invention proposes a system for dispensing a fluid product packaged in a bottle, said system comprising a device for sampling the packaged product which has a body secured to the bottle in order to be supplied with product and a nozzle overmounting said body, said nozzle being able to be reversibly displaced on an axial course that is respectively descending for dispensing and ascending for suction of the product, said system comprising:
a ring secured to the bottle and wherein the body of the device is sealingly fixed, said ring having two upper arms arranged on either side of the nozzle which is provided with two external lugs, said arms each having an internal lug arranged in the axial continuation of an external lug to form a housing between them;
a support having a duct for dispensing the product, the arms being mounted in translation in said support by placing the nozzle in communication with said duct;
a push-button for actuating the device for sampling which is mounted in radial translation with respect to the support, said push-button having two tabs arranged respectively in a housing formed between the lugs, said tabs each having an upper bearing surface bearing against an internal lug and a lower bearing surface bearing against an external lug, said bearing surfaces diverging radially so that a depression of the push-button causes the lugs to separate in order to actuate the device for sampling by depressing the nozzle and raising the bottle;
   said system having an applicator of the product which is mounted on the support, said mounting being arranged to allow for the relative rotation of said applicator with respect to said support by placing into sealed communication a dispensing orifice of the applicator with the dispensing duct.

According to a second aspect, the invention proposes a method for assembling such a system for dispensing, said method providing for:
mounting the cap on the lower end of the bottle;
sliding the bottle into the case until the cap is secured on the bottom of the case;
sliding the bottle with respect to the cap in order to mount said bottle on the device for sampling, said sliding being carried out on a course arranged to allow for the translation of the lower end in said cap during the actuating of the device for sampling.

### BRIEF DESCRIPTION OF THE DRAWINGS

Other objects and advantages of the invention shall appear in the following description, made in reference to the annexed figures, wherein:

FIG. 1A is an exploded perspective view of a system for dispensing according to an embodiment of the invention, FIGS. 1B-1E being enlarged views respectively of the insert of the support bearing the dispensing duct, of the tip bearing the external lugs, of the ring and of the push-button;

FIGS. 2A-2B show the applicator of FIG. 1A, respectively as a front view (FIG. 2A) and as a longitudinal cross-section (FIG. 2B);

FIG. 3 is a perspective view of the mounting socle of the applicator of FIGS. 1, 2;

FIG. 4 is an enlarged view as a partial cross-section of the upper opening of the support of FIG. 1A;

FIG. 5A is an enlarged view as a partial cross-section of the upper portion of the system for dispensing of FIG. 1A, FIG. 5B being an enlargement of the zone A of FIG. 4;

FIGS. 6A-6F show as a longitudinal cross-section the system for dispensing of FIG. 1A during different steps of its assembly.

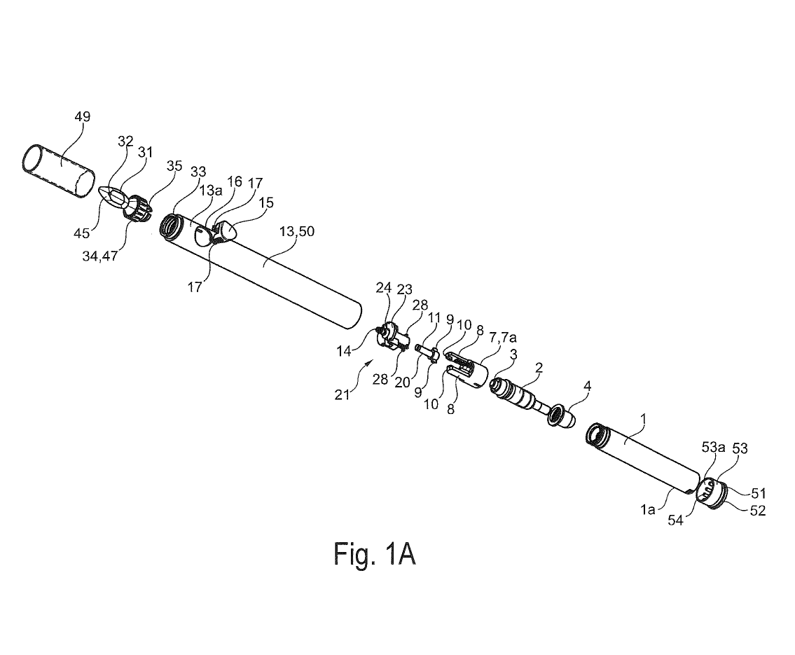

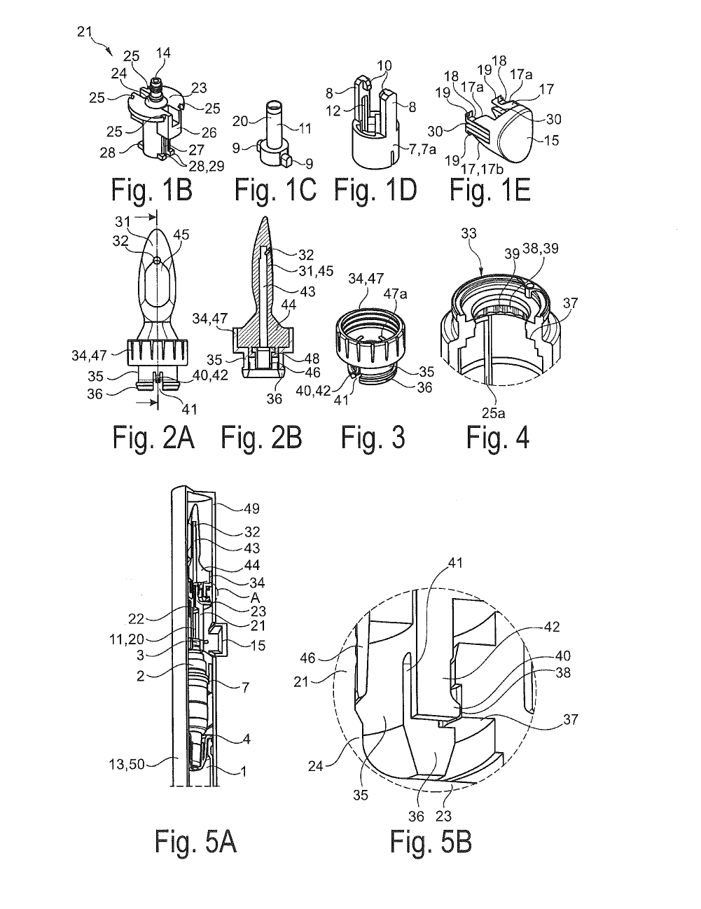

### DETAILED DESCRIPTION OF THE INVENTION

In relation with the figures, a system for dispensing a fluid product packaged in a bottle 1 is described, said product may be a gel or a cream, for example for use in cosmetics or for pharmaceutical treatments.

The system comprises a device 2 for sampling the packaged product that has a body secured to the bottle 1 in order to be supplied with product and a nozzle 3 overmounting said body. In particular, the bottle is associated under the body of the device for sampling 2 by means of a connector 4 arranged in order to provide for the seal of this assembly.

In the embodiment shown, the device for sampling is a pump 2 without the invention being limited to such an embodiment, said pump may be of the type airless intake by being supplied with product, by way of example, by the action of a scraper piston sliding in the bottle 1.

In order to allow for the sampling of the product, the nozzle 3 can be reversibly displaced over an axial course respectively descending for dispensing and ascending for suction of the product. In particular, the nozzle 3 can comprise a tube which is arranged in the body of the pump 2 by forming a dosage chamber in communication with the bottle 1 by the intermediary of a valve, a spring 5 being provided to recall said nozzle over its course of suction.

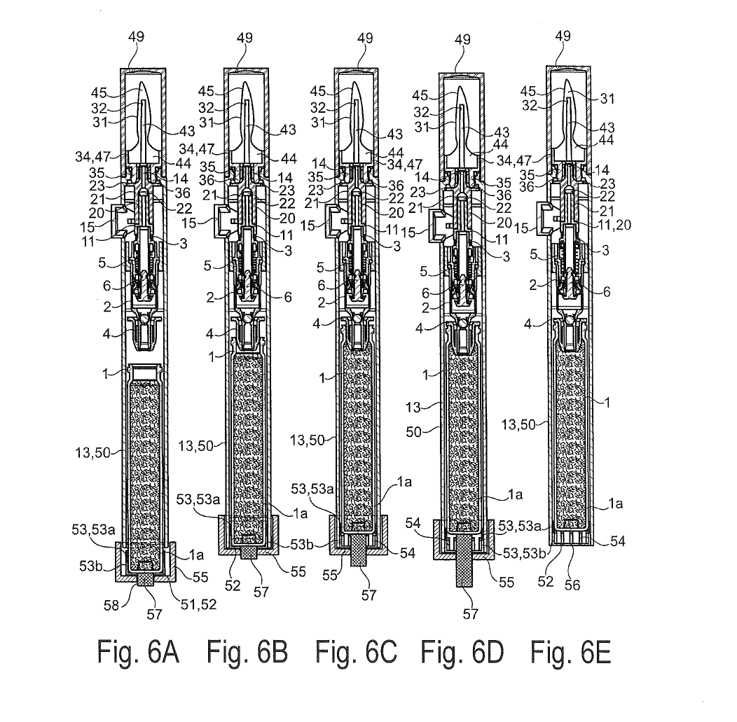

In relation with FIGS. 6A-6E wherein it is as a cross-section, the pump 2 is of the type of that described in document FR-2 908 843, i.e. comprising a needle 6 arranged in the nozzle 3 in order to open—respectively close—the communication between said nozzle and the dosage chamber over the course of distribution—respectively suction. However, the invention is not limited to a particular pump 2 structure, in particular concerning the means required for the sampling under pressure of the product to be dispensed.

The system comprises a ring 7 secured to the bottle 1 and wherein the body of the pump 2 is sealingly fixed. To do this, the ring 7 has a tubular portion 7a wherein the body of the pump 2 is mounted via sealed press-fitting.

The ring 7 has two upper arms 8 which are arranged on either side of the nozzle 3. In particular, the arms 8 are formed of a single piece with the tubular portion 7a by being fixedly associated on its upper edge.

In the embodiments shown, the nozzle 3 is provided with an added tip 11 whereon two external lugs 9 are formed. In particular, the tip 11 has a bore for mounting on the nozzle 3, the lugs 9 extending radially by being diametrically distributed around said bore. In an alternative not shown, the lugs 9 can be formed directly on the nozzle 3.

The arms 8 each have an internal lug 10 which is arranged above and in the axial continuation of an external lug 9 to form a housing between them.

Moreover, the internal lugs 10 extend radially by being formed in the vicinity of the upper ends of the arms 8, each of said arms having an axial groove 12 wherein an external lug 9 is guided in translation.

The system comprises a support 13 which has a duct 14 for dispensing the product, the arms 8 being mounted in translation in said support by placing the nozzle 3 in communication with the dispensing duct 14.

The system comprises a push-button 15 for actuating the device for sampling 2 which is mounted in radial translation with respect to the support 13. To do this, the support 13 comprises a lateral wall 13a which is provided with a lateral opening 16 wherein the push-button 15 is mounted in translation. Furthermore, the push-button 15 can be surrounded by an embellishment for masking the edge of the lateral opening 16.

The push-button 15 has two tabs 17 arranged respectively in a housing formed between the lugs 9, 10, said tabs extending radially in the lateral opening 16 in order to be arranged respectively between an arm 8 and the tip 11, said tabs surrounding the nozzle 3. The tabs 17 each have an upper bearing surface 17a bearing against an internal lug 10 and a lower bearing surface 17b bearing against an external lug 9, said bearing surfaces diverging radially so that a depression of the push-button 15 causes the lugs 9, 10 to separate.

As such, the actuating of the device for sampling 2 is carried out by combining a depression of the nozzle 3 with a raising of the bottle 1, which makes it possible to limit the course and the effort of the actuating in translation of the push-button 15. Furthermore, after the releasing of the push-button 15, the recalling of the nozzle 3 over its course of suction actuates the returning to the position at rest of the push-button 15 and of the bottle 1. According to an embodiment, the bearing surfaces 17a, 17b have a slope of 35° in order to, over a course lower than 3.5 mm, dispense a dose of a magnitude of 120 μl.

In the embodiments shown, the tabs 17 have an upper face and a lower face, each one of said faces comprising an imprint 18 which is bordered in the front by an outer edge 19 and in the rear by a bearing surface 17a, 17b. As such, the position at rest of the push-button 15 is defined by disposing a lug 9, 10 in respectively an imprint 18 which has a dimension substantially equal to that of said lug.

The outer edges 19 have a bevelled end in order to allow for the arrangement of the tabs 17 in the housings formed between the lugs 9, 10. In particular, during this arrangement, the lugs 9, 10 are separated by being placed into bearing against the edges 19, which causes an actuating of the pump 2 that can for example be used for its pre-priming.

Moreover, the lugs 9, 10 interact with an outer edge 19 in order to prevent the removal of the push-button 15. To do this, the outer edges 19 have a rear slope which is straight in order to prevent the removal of the lugs 9, 10 after their arrangement in the imprints 18.

Advantageously, the tip 11 provided on the nozzle 3 has an upper shaft 20 which is mounted in translation in the dispensing duct 14. In particular, the tip 11 comprises an upper portion wherein the shaft 20 is formed by being in communication with the nozzle 3.

In relation with the figures, the support 13 comprises an insert 21 fixed to the inside of said support, said insert having the dispensing duct 14.

This realisation makes it possible to define in the dispensing duct 14 a buffer chamber 22 for the sampled product of which the volume is increasing—respectively decreasing—over the course of dispensing—respectively suction—of the nozzle 3. In particular, the buffer chamber 22 comprises a cylindrical lower portion wherein the shaft 20 is mounted in translation and a conical upper portion that converges towards the dispensing duct 14. The buffer chamber 22 can have a variation in volume which is between 30% and 100% of the dose of product sampled by the pump 2.

As such, it is possible to obtain a gesture wherein the distribution is at least partially dissociated from the application of the product. Indeed, the pressing on the push-button 15 causes the filling of the buffer chamber 22 with at least a portion of the dose sampled and, after releasing of said push-button, the dose is dispensed by a decrease in the volume of said buffer chamber.

The insert 21 has an upper plate 23 whereon extends a cone 24 through which passes the dispensing duct 14, said plate having four notches 25 distributed in pairs on either side of the cone 24, said notches being engaged in respectively an axial groove 25a formed inside the support 13.

The grooves 25a allow for the upright mounting of the insert 21 by sliding inside the support 13 until fastening of the plate 23 in said support, in particular by snap-fitting. Furthermore, the insert 21 has a U-shaped bridge 26 formed between each of the pairs of notches 25 in order to improve the guiding in sliding of the insert 21 into the support 13, in particular by limiting the swiveling of said insert before snap-fitting.

The insert 21 also has two axial slots 27 formed respectively under a U-shaped bridge 26, an internal lug 10 being guided in translation in respectively one slot 27 during the actuating of the system. In particular, the arms 8 are guided in translation in the support 13 between two grooves 25a.

The lower end of each of the edges of the slots 27 is provided with a lug 28. In particular, the two lugs 28 of a slot 27 form a radial slide 29 in order to allow for the guiding in translation of the push-button 15. To do this, each tab 17 has a central recess 30 wherein two lugs 28 of a slot 27 are arranged.

In order to improve the ergonomics of the dispensing of the product, the system has an applicator 31 which is mounted on the support 13, said mounting being arranged in order to allow for the relative rotation of said applicator with respect to said support by placing in sealed communication a dispensing orifice 32 of the applicator 31 with the dispensing duct 14.

As such, in order to be able to apply the product on a portion of the body, for example on the lips, a user can selectively orient the applicator and more particularly its orifice 32, in particular according to their own habits and/or to the position of said portion of the body, then press on the push-button 15 before pressing and displacing said applicator along said portion in order to spread the product therein, which constitutes a particularly intuitive gesture.

In relation with the figures, the support 13 comprises an upper opening 33 wherein the applicator 31 is mounted in rotation, said upper opening being located above the lateral opening 16 for receiving the push-button 15. In addition, the axis of rotation of the applicator 31 is perpendicular to the axis of translation of the push-button 15.

The applicator 31 comprises a socle 34 for mounting in rotation on the support 13, this socle 34 comprising an outer skirt 35 bearing a lower annular snap bead 36 which is snap-fitted with the possibility of relative rotation under an annular edge 37 of the support 13.

In relation with the figures, the socle 34 for mounting is arranged in the upper opening 33 of the support 13, said upper opening having an annular edge 37 that protrudes inside of it and under which the annual snap bead 36 of said socle is snap-fitted with the possibility of relative rotation.

The support 13 comprises an axial annular ramp 38 formed above the snap-fitting edge 37 and having notches 39 distributed angularly. Moreover, the outer skirt 35 bears at least one prong 40 which is arranged bearing against the ramp 38 in order to induce an effort of differential rotation by successive passages of said prong on said notches during the relative rotation of the applicator 31 with respect to the support 13.

In particular, the effort of differential rotation can be arranged in order to prevent the relative rotation by blocking of the prong 40 in a notch 39 of the ramp 38, in particular during the application of product on a portion of the body of the user, and this while still allowing said user to rotate the applicator 31 about its axis by exerting on it an effort that is sufficiently substantial to allow for the displacement of the prong 40 on the ramp 38. Furthermore, the ramp 38 can be arranged so that the displacement of the prong 40 on it generates a characteristic noise at each passage of said prong 40 in a notch 39.

The outer skirt 35 comprises at least one notch 41 wherein a tab 42 extends axially, said tab bearing a prong 40 arranged axially above the snap bead 36. In the embodiment shown, the outer skirt 35 comprises two diametrically opposed notches 41 which each comprise a tab 42 bearing a prong 40.

Furthermore, the applicator 31 comprises a channel 43 that extends from a base 44 and opens into a dispensing orifice 32 formed on a lateral surface 45 of application. Moreover, in order to place in communication the dispensing orifice 32 with the dispensing duct 14, the socle 34 for mounting comprises an inner skirt 46 wherein said dispensing duct is mounted in rotation, the base 44 being fixed on the socle 34 in such a way that the dispensing duct 14 opens into the channel 43.

In particular, the applicator 31 is overmoulded on the socle 34. As such, it can be provided to form an applicator 31 with a different material, and in particular more flexible, than the material of the socle 34. Furthermore, the socle 34 comprises a bucket 47 extending above the skirts 35, 46 and wherein the applicator 31 is overmoulded, said bucket comprising notches 47a arranged in its bottom and wherein a portion of the overmoulded material extends in order to form between the skirts 35, 46 anchoring hooks 48 of the applicator 31 in the socle 34.

The system further comprises a cover 49 intended to be reversibly arranged around the applicator 31 between two uses.

In order to improve its aesthetics, the system comprises a case 50, wherein the bottle 1 is mounted in translation during the actuating of the device for sampling 2. In the embodiment shown, the case 50 is integrated to the support 13 in order to surround the bottle 1, but it can also be associated with said support as an added part.

Moreover, the system comprises a cap 51 secured to the bottom of the case 50, the lower end 1a of the bottle being mounted in translation in said cap during the actuation of the device for sampling 2.

To do this, the cap 51 comprises a flat portion 52 of which an annular peripheral portion 53 extends axially upwards, said peripheral portion having an upper bearing surface 53a which is arranged for the guiding in translation of the lower end 1a in said upper bearing surface with minimum peripheral play.

As such, the cap 51 makes it possible not only to mask the bottle 1, which improves the aesthetics of the system, but also to maintain the bottle 1 upright and to guide it in translation in the case 50, in order to prevent any untimely lateral movement of said bottle while at rest as well as during the actuating of the device for sampling 2.

In relation with FIGS. 6A-6F, a method for assembling a system for dispensing is described hereinbelow, and in particular the steps of assembling the bottle 1, wherein the product to be dispensed was packaged beforehand.

The method firstly provides to mount the cap 51 on the lower end 1a of the bottle 1.

To do this, the peripheral portion 53 of the cap 51 further has a lower bearing surface 53b for mounting on the inside face of which axial ribs 54 are distributed angularly, said ribs forming between them a space with a diameter substantially equal to the outer diameter of the lower end 1a.

As such, in order to mount the cap 51, the lower end 1a is disposed against the lower bearing surface 53b, in such a way that the ribs 54 come into tight contact on said lower end in order to provide for the maintaining of said cap on said lower end.

Once the cap 51 is mounted on the bottle 1, the method provides for sliding the bottle 1 into the case 50 until the cap 51 is secured on the bottom of the case 50. In particular, the peripheral portion 53 has an outer diameter that is substantially equal to the inner diameter of said bottom, so that said peripheral portion comes into tight contact in the bottom of the case 50.

In relation with FIGS. 6A-6B, the lower end 1a provided with the cap 51 is arranged in a bucket 55 which is displaced axially upwards in order to allow for the sliding of said bottle into the case 50 and the attaching of said cap to said case (FIGS. 6A, 6B).

The method furthermore provides to slide the bottle 1 in relation to the cap 51 in order to mount said bottle on the device for sampling 2, said sliding being carried out on a course arranged to allow for the translation of the lower end 1a in said cap during the actuating of the device for sampling 2.

In relation with FIGS. 6B to 6E, the bottle 1 is made to slide on a course equal with the height of the portion of mounting 53b and materialised by the ribs 54, in order to be arranged in the portion of guiding 53a located immediately above said portion of mounting. Furthermore, the portion of guiding 53a has an inner diameter that is slightly greater than that of the portion of mounting 53b and arranged in order to allow for the guiding in translation of the bottle 1 into the case 50 with a minimum lateral play between the lower end 1a and the cap 51.

Furthermore, the cap 51 has a central hole 56 formed on its flat portion 51, the sliding of the bottle 1 in relation to the cap 51 being carried out by pushing on the lower end 1a by means of a finger 57 inserted into said central hole. In relation with FIGS. 6A-6E, the bucket 55 comprises a hole 58 that is placed across from the central hole 56 of the cap 51 when the lower end 1a is disposed in said bucket, the finger 57 passing in the holes 58, 56 in order to bear against said lower end in order to slide the bottle 1.

According to an embodiment, the hole 56 can be plugged after the assembly, for example by a self-adhesive label, in order to improve the aesthetics of the system. In particular, the label can include a pattern, for example a logo of the brand of the product packed in the bottle 1, or legal information.

1. System for dispensing a fluid product packaged in a bottle, said system comprising a device for sampling a packaged product which has a body secured to the bottle in order to be supplied with product and a nozzle overmounting said body, said nozzle able to be reversibly displaced over an axial course respectively descending for dispensing and ascending for the suction of the product, said system comprising:
a ring secured to the bottle and wherein the body of the device is sealingly fixed, said ring having two upper arms arranged on either side of the nozzle which is provided with two external lugs, said arms each having an internal lug arranged in the axial continuation of an external lug to form a housing between them;
a support having a duct for dispensing the product, the arms being mounted in translation in said support by placing the nozzle in communication with said duct;
a push-button for actuating the device for sampling which is mounted in radial translation with respect to the support, said push-button having two tabs arranged respectively in a housing formed between the lugs, said tabs each having an upper bearing surface bearing against an internal lug and a lower bearing surface bearing against an external lug, said bearing surfaces diverging radially so that a depression of the push-button causes the lugs to separate in order to actuate the device for sampling by depressing the nozzle and raising the bottle;
said system being characterised in that it has an applicator of the product which is mounted on the support, said mounting being arranged to allow for the relative rotation of said applicator with respect to said support by placing into sealed communication a dispensing orifice of the applicator with the dispensing duct.

2. System for dispensing according to claim 1, characterised in that the axis of rotation of the applicator is perpendicular to the axis of translation of the push-button.

3. System for dispensing according to claim 1, characterised in that the support comprises a lateral opening wherein the push-button is mounted in translation, as well as an upper opening wherein the applicator is mounted in rotation.

4. System for dispensing according to claim 1, characterised in that the applicator (31) comprises a socle for mounting in rotation on the support, the socle comprising an outer skirt bearing a lower annular snap bead which is snap-fitted with the possibility of relative rotation under an annular edge of the support.

5. System for dispensing according to claim 4, characterised in that the support comprises an annular axial ramp formed above the snap-fitting edge and having notches distributed angularly, at least one prong borne by the outer skirt being arranged bearing against the ramp in order to induce an effort of differential rotation by successive passages of said prong on said notches during the relative rotation of the applicator with respect to the support.

6. System for dispensing according to claim 5, characterised in that the outer skirt comprises a least one notch wherein a tab extends axially, said tab bearing a prong arranged axially above the snap bead.

7. System for dispensing according to claim 4, characterised in that the socle comprises an inner skirt wherein the dispensing duct is mounted in rotation.

8. System for dispensing according to claim 1, characterised in that the applicator is overmounted on the socle.

9. System for dispensing according to claim 1, characterised in that the nozzle is provided with an added tip whereon the external lugs are formed, said tip being mounted in translation in the dispensing duct.

10. System for dispensing according to claim 1, characterised in that the support comprises an insert fixed to the inside of said support, said insert having the dispensing duct.

11. System for dispensing according to claim 1, characterised in that it comprises a case wherein the bottle is mounted in translation during the actuating of the device for sampling.

12. System for dispensing according to claim 11, characterised in that the case (50) is associated or integrated to the support in order to surround the bottle.

13. System for dispensing according to claim 1, characterised in that it comprises a cap secured to the bottom of the case, the lower end of the bottle being mounted in translation in said cap during the actuating of the device for sampling.

14. System for dispensing according to claim 13, characterised in that the cap has a central hole.

15. Method for assembling a system for dispensing according to claim 13, said method providing for:
mounting the cap on the lower end of the bottle;
sliding the bottle into the case until the cap is secured on the bottom of the case;
sliding the bottle with respect to the cap in order to mount said bottle on the device for sampling, said sliding being carried out on a course arranged to allow for the translation of the lower end in said cap during the actuating of the device for sampling.

16. Method for assembling according to claim 15 when it depends on claim 14, characterised in that the sliding of the bottle with respect to the cap is carried out by pushing on the lower end by means of a finger inserted into the central hole of the cap.

17. System for dispensing according to claim 2, characterised in that the support comprises a lateral opening wherein the push-button is mounted in translation, as well as an upper opening wherein the applicator is mounted in rotation.
